(19) United States
(12) Patent Application Publication
(10) Pub. No.: US 2008/0043664 A1
(43) Pub. Date: Feb. 21, 2008

(54) METHOD AND SYSTEM FOR REDUCING TRANSMISSION ROUTE OF PACKET IN INTERNET BASED NESTED MOBILE NETWORK

(76) Inventors: Sung Hei KIM, Daejeon (KR); Yoon Young AN, Daejeon (KR); Sang Ha KIM, Daejeon (KR); Tae Il KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/676,610

(22) Filed: Feb. 20, 2007

(30) Foreign Application Priority Data
Aug. 21, 2006 (KR) 10-2006-79026

(51) Int. Cl. H04Q 7/00

(52) U.S. Cl. 370/328

(57) ABSTRACT

A method and system for reducing transmission route of packet in Internet based nested mobile network are provided. In the method, a plurality of routers in an Internet based nested mobile network register location information using a top-level mobile router. Then, each of the mobile routers creates NEMO routing information. A packet is received through own home agent using the location information registered at the top-level router in the nested mobile network when a terminal in the outside of the mobile network transmits a packet. The receive packet is processed through the created NEMO routing information at the top-level router.

### CLAIM OF PRIORITY

This application claims the benefit of Korean Patent Application No. 2006-79026 filed on Aug. 21, 2006 in the Korean Intellectual Property Office, the disclosure of which is incorporated herein by reference.

### BACKGROUND OF THE INVENTION

1. Field of the Invention

The present invention relates to a method and system for reducing transmission route of packet in Internet based nested mobile network and, more particularly, to a method and system for reducing the transmission route of a packet transmitted to low-level mobile routers in a nested mobile network.

2. Description of the Related Art

In Internet based communication network, a terminal transfers packets to a destination terminal through a plurality of routers using an IP address. In such an Internet based communication network, as shown in FIG. 1, a first terminal 10, a home agent 20, and an access router 30, are connected to an IPv6 based Internet network. The home agent 20 and the access router 30 interact with a mobile network 50 by communicating with each other in wireless manner through an access point (base station) (41, 42). The mobile network 50 includes a mobile router 51, a visiting mobile terminal 52 connected to a low-level interface of the mobile router 51, a local stationary terminal 53, a local stationary router 54, and a visiting mobile router 55. When the mobile router 51 in the mobile network 50 moves, the mobile router 51 disconnects a communication link to the current home agent 20 and creates a communication link to a new access router 30 through communicating with a new access point 42 in a wireless manner after moving. FIG. 1 shows a mobile network 50 before a mobile router moves and a mobile network 50 after the mobile router moves. As shown in FIG. 1, the first terminal 10 transfers a packet to a destination terminal through a mobile router 51a connected to the home agent 20 before the mobile router 51 moves. After the mobile router 51 moves, the first terminal 10 transfers the packet to a destination terminal through a mobile router 51b connected to the new access router 30.

According to network mobility (NEMO) in an internal based mobile network, many mobile routers are nested. That is, since routers move in the internal based mobile network, may mobile routers are overlapped. In order to transfer a packet from a terminal outside of the nested mobile network to a low-level mobile router, the packets in the outside of the nested mobile network must be processed differently from the packets in the nested mobile network.

In the case of processing the packets in the outside of the mobile network, a low-level mobile router does not know about the mobility of a top-level mobile router. Therefore, the low-level mobile router provides information about a upper-level mobile router to a home agent. When a packet is transferred to a terminal connected to a low level mobile router, packets passes through home agents of all of upper level mobile routers. Then, the home agents receive the packets and add new header into the received packet. In the worst case, packets need to be transferred to entire network at the outside of a mobile network. In this case, the length of a packet becomes excessively increased because home agents add headers to the packet.

In the case of processing packets inside the mobile network, packets are received from an upper level mobile router, and a predetermined process is performed. For example, a header added by an own home agent is removed from the received packet. Since each of the mobile routers must process a packet to transfer the packet, it is not effective. Therefore, there is a demand for developing a method and system for effectively processing packets in a mobile network.

### SUMMARY OF THE INVENTION

The present invention has been made to solve the foregoing problems of the prior art and therefore an aspect of the present invention is to provide a method and system for reducing a packet transmission route from the home agent of a low level mobile router to the low level mobile router by enabling the low-level mobile router to provide information about a top-level mobile router to the home agent of the low-level router in a nested mobile network.

Another aspect of the present invention is to provide a method and system for reducing a packet transmission route by processing packets inputting to a mobile network at a top-level router and processing packets outputted from a mobile network at a mobile router closest to a terminal transmitting the packet in order to minimize packet processing in a mobile network.

According to an aspect of the invention, the invention provides a method for reducing transmission route of packet in Internet based nested mobile network. In the method, a plurality of routers in an Internet based nested mobile network register location information using a top-level mobile router. Then, each of the mobile routers creates NEMO routing information. A packet is received through own home agent using the location information registered at the top-level router in the nested mobile network when a terminal in the outside of the mobile network transmits a packet. The receive packet is processed through the created NEMO routing information at the top-level router.

According to another aspect of the invention for realizing the object, there is provided a system for reducing a packet transmission route including a top-level router, and at least one of low-level mobile routers. The top-level router registers a location to an own home agent, and transmits NEMO (network mobility) advertisement message having an own CoA (Care-of-Address) and packets received from an external terminal to a low-level interface according to previously created NEMO routing information. At least one of the low-level mobile routers register the CoA included in the NEMO advertisement message received from the top-level router to an own home agent as own location information, and transfer a received packet to a destination terminal according to previously created NEMO routing information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an IPv6 based Internet system;

FIG. 2 is a block diagram illustrating the structure of a nested mobile network in an IPv6 based Internet according to an embodiment of the present invention;

FIG. 3 is a diagram illustrating location information registered at each home agent by mobile routers in a nested mobile network according to an embodiment of the present invention;

FIG. 4 is a diagram illustrating network mobility (NEMO) routing information created by mobile routers in a nested mobile network according to an embodiment of the present invention;

FIG. 5A and FIG. 5B are diagrams illustrating a procedure for transferring a packet from a first terminal to a second terminal in a nested mobile network according to an embodiment of the present invention;

FIG. 6 is a diagram illustrating a structure of a packet transferred from a first terminal to a second terminal in a nested network;

FIG. 7A and FIG. 7B are diagrams illustrating a method for processing packets transferred from a second terminal to a first terminal in a nested mobile network according to an embodiment of the present invention;

FIG. 8 is a diagram illustrating a structure of a packet transferred from a second terminal to a first terminal in a nested mobile network according to an embodiment of the present invention;

FIGS. 9A through 9C are flowcharts illustrating the operation of a top-level mobile router in a nested mobile network according to an embodiment of the present invention;

FIG. 10A to FIG. 10C are flowcharts illustrating operation of a low-level mobile router in a nested mobile network according to an embodiment of the present invention; and

FIG. 11A and FIG. 11B are flowcharts illustrating a method of creating and processing NEMO routing information in a mobile router in a nested mobile network according to an embodiment of the present invention.

### DETAILED DESCRIPTION OF THE PREFERRED EMBODIMENT

Certain embodiments of the present invention will now be described in detail with reference to the accompanying drawings. Like numeral references denotes like element in the accompanying drawings. In order to clearly describe the present invention, descriptions of related well-known functions or structures may be omitted.

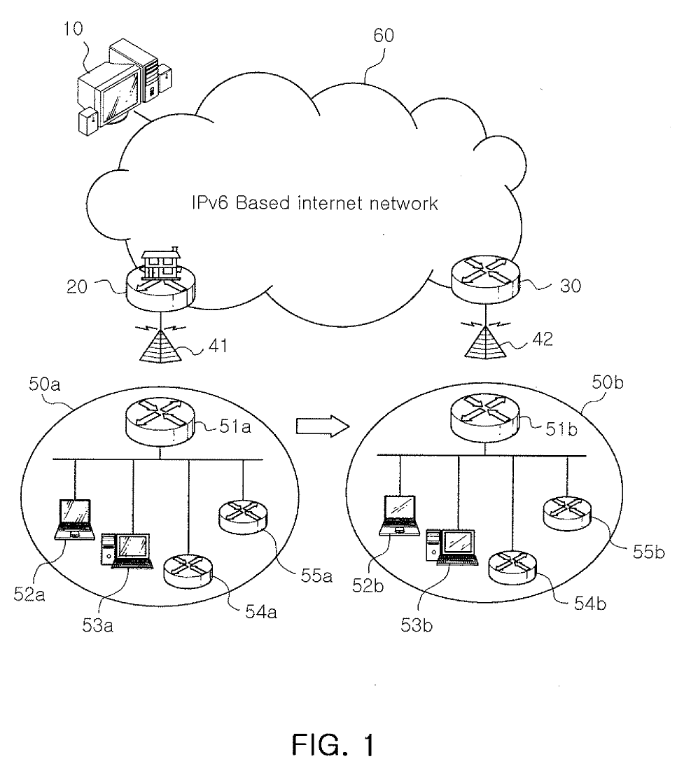

A method and system for reducing packet transmission route according to an embodiment of the present invention will be described with an IPv6 based Internet applied. In the IPv6 Internet (hereinafter, Internet), as shown in FIG. 1, a terminal interacts with a mobile network including a home agent and a plurality of routers to transfer a packet to a destination terminal. In the certain embodiment of the present invention, a nested mobile network formed of mobile routers is applied. The nested mobile network will be described with reference to the accompanying drawings.

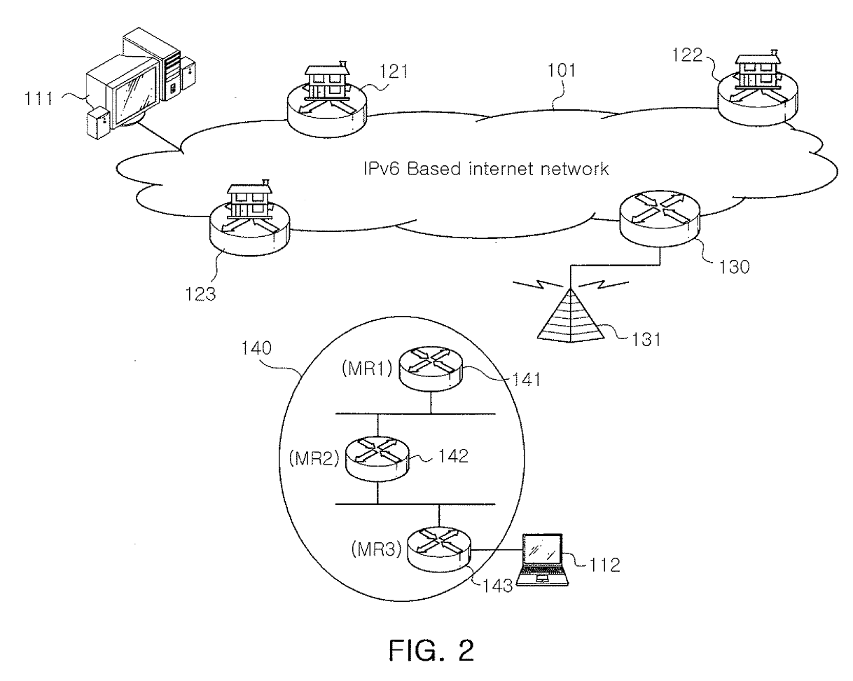

FIG. 2 is a block diagram illustrating the structure of a nested mobile network in an IPv6 based Internet according to an embodiment of the present invention.

Referring to FIG. 2, the IPv6 based Internet includes a plurality of home agents 121, 122, and 123, and an access router 130. A nested mobile network 140 is connected to the IPv6 based Internet network through an access point 131, a base station.

The nested mobile network MN 140 includes a plurality of mobile routers MR1, MR2, and MR3 141, 142, and 143, and a second terminal 112. The nested mobile network MN 140 ( [symbol] 2 [symbol] 140^{o}┐ [symbol] . may have a nested level higher than three, which is the number of mobile router layers. Referring to FIG. 2, the nested mobile network will be described to have the nested level of three in the present embodiment. However, the nested mobile network can have the nested level of two. The mobile network is generally formed in a bus, a train, or an airplane. Such a mobile network enables terminals and routers to access the Internet although the entire mobile network is moving.

Each of home agents (HA) 121, 122, and 123 manages corresponding mobile routers 141, 142, and 143, and transfers packet from a first terminal 111 to the mobile routers 141, 142, and 143.

The first mobile agent 121 is a mobile agent for the first router MR1 141. The first mobile router 141 is the top-level mobile router and provides Internet service to the mobile network 140 by accessing the Internet network 101. Therefore, the mobile router 141 accesses the access router 130 through an access point 131.

The second home agent 122 is a home agent of the second mobile router 142. The second mobile router 142 is not a top-level router so the second mobile router 142 accesses the Internet through the first mobile router 141.

The third home agent 123 is a home agent of the third mobile router 143, and the third mobile router 143 is connected to the second mobile router 142 and connected to a second terminal 112 communicating with the first terminal 111.

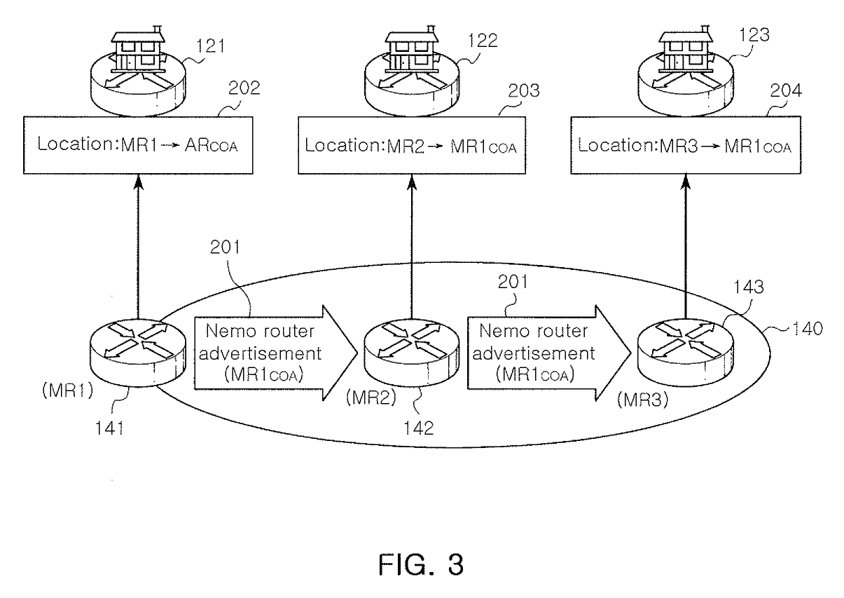

The mobile routers 141, 142, and 143 register location information to corresponding home agents 121, 122, and 123. The location information will be described with reference to FIG. 3.

Referring to FIG. 2 and FIG. 3, when the first mobile router 141 accesses a new access router AR 130, the first mobile router 141, top-level router, is allocated with a new address from the access router 130. Such an address is a Care-of -Address (CoA), and a CoA received from the access router 130 is an AR_{CoA}.

The first mobile router 141 is allocated with AR_{CoA} whenever the first mobile router 141 accesses to a new network, and registers locations to the first home agent 121. Therefore, the first home agent 121 records the location information of the first mobile router 141 as ‘MR1 [symbol] AR_{CoA}’ 202.

The first mobile router 141 transfers a network mobility (NEMO) router advertisement message 201 having own information to all low-level routers 142 and 143 in the mobile network 140. At this moment, the second mobile router 142 transfers the NEMO router advertisement message from the first mobile router 141 to the third mobile router 143. The NEMO router advertisement message 201 is a general router advertisement message, which is transmitted from a router to an adjacent terminal or router, with information about the top-level router. The NEMO router advertisement message 201 includes a MR1_{CoA} generated from the first router 141.

Then, the low-level routers, the second and third mobile routers 142, and 143, receive the NEMO router advertisement message 201, and registers the location thereof with the MR1_{CoA} included in the received NEMO router advertisement message 201 to the corresponding home agents 122 and 123. That is, the second home agent 122 records the location information of the second mobile router 142 as ‘MR2 [symbol] MR1_{CoA}’ 203, and the third home agent 123 records the location information of the third mobile router 143 as ‘MR3 [symbol] MR1_{CoA}’ 204.

The mobile routers in the nested mobile network exchange routing information using a general routing protocol. Therefore, the routing information exchanged with the mobile routers in the nested mobile network is required to be discriminated from general routing information. The routing information created by the mobile routers is defined as NEMO routing information. The NEMO routing information is used by mobile routers to process packets received from the external networks and to process packets to transfer to the external networks. Hereinafter, NEMO routing information will be described with reference to the accompanying drawings.

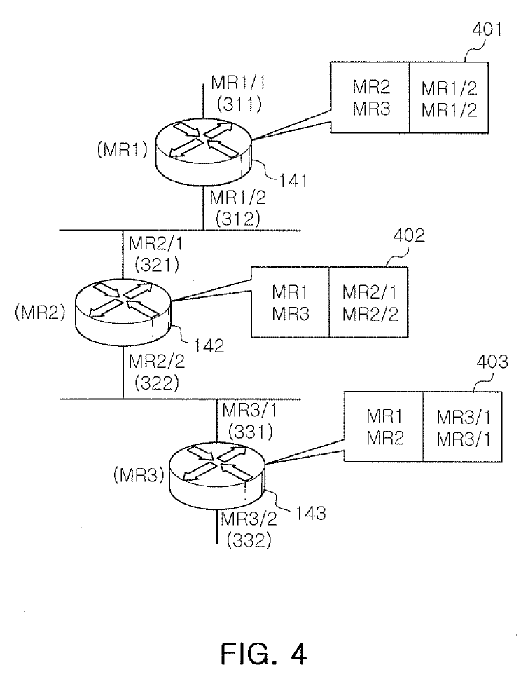

FIG. 4 is a diagram illustrating NEMO routing information about a network formed of mobile routers in a nested mobile network according to an embodiment of the present invention.

Referring to FIG. 4, the first mobile router 141, the top-level router, has a high-level interface and a low-level interface. Herein, the high-level interface and the low-level interface must be discriminated in order to form a nested network between mobile routers.

MR1/1 denotes the high-level interface 311 of the first mobile router 141, and MR1/2 denotes the low-level interface 312. They are discriminated because it needs to process received packets differently. Similarly, in the second mobile router 142, MR2/1 denotes the high-level interface 321, and MR2/2 denotes the low-level interface 322. In the third mobile router 143, MR3/1 denotes the high-level interface 331, and MR3/2 denotes the low-level interface 332. Herein, the mobile routers have one interface but the mobile routers may have a plurality of low-level interfaces. In the present invention, the mobile router is described to have one low-level interface for convenience.

Generally, mobile routers in a mobile network exchange own address information and interface information. Therefore, these information are created similarly based on a general routing protocol.

In order to create NEMO routing information according to an embodiment of the present invention, each of the mobile routers 141, 142, and 143 has own mobile routing information 401, 402, and 403 as NEMO routing information as shown in FIG. 4. For example, the mobile routing information 401 of the first mobile router 141 is created to have information to transfer a packet to MR2 to a MR1/2 interface and to transfer a packet to MR3 to a MR1/2 interface. Similarly, the mobile routing information 402 and 403 are created to have information about packet transmission route.

Hereinafter, a method for creating a packet transmission path and processing packets in an IPv6 based Internet network having the nested mobile network will be described with reference to the accompanying drawings. At first, a method of processing packet transferred from a first terminal to a second terminal will be described.

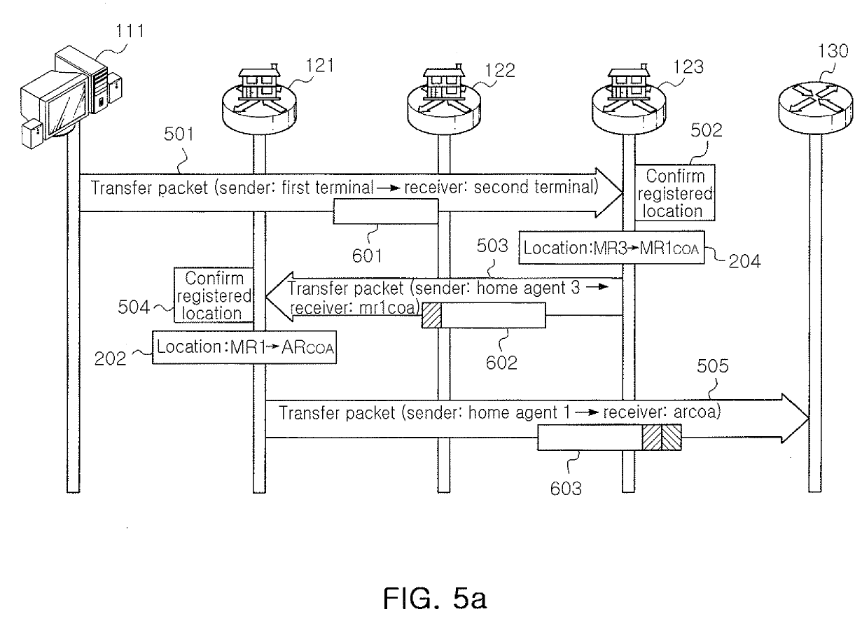

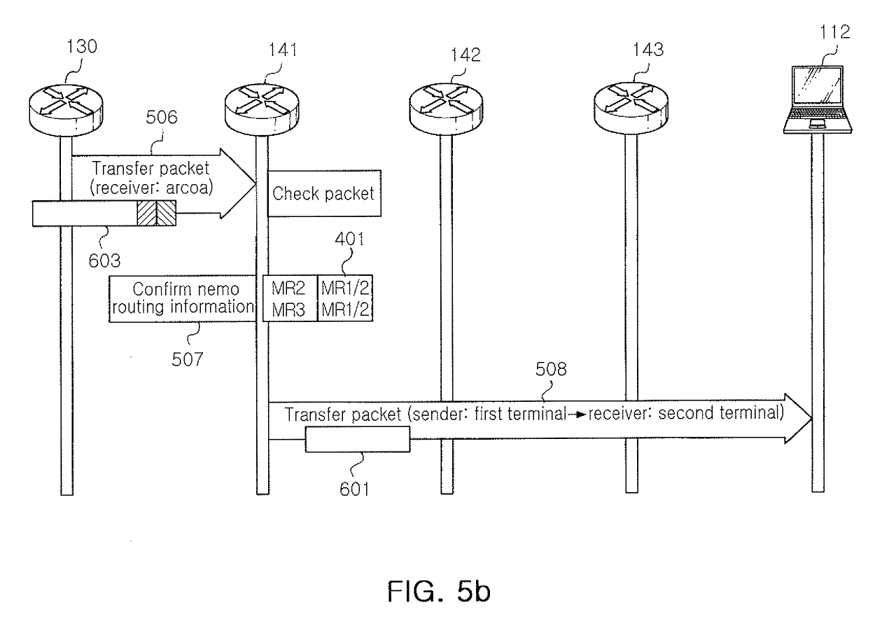

FIG. 5A and FIG. 5B are diagrams illustrating a procedure for transferring a packet from a first terminal to a second terminal in a nested mobile network according to an embodiment of the present invention.

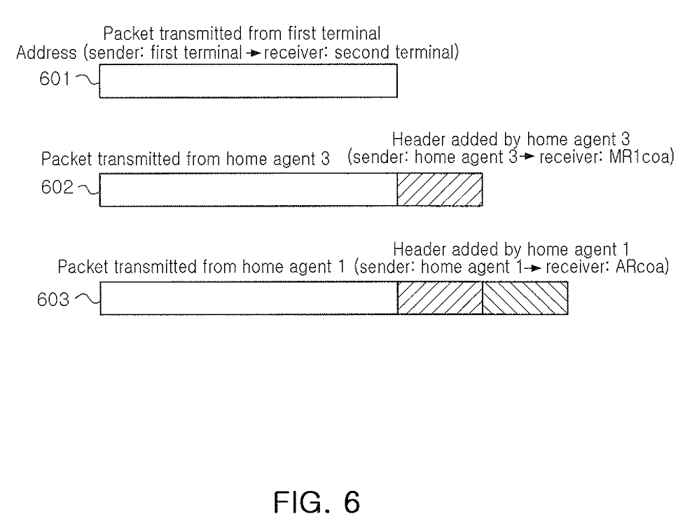

Referring to FIG. 5A, the first terminal 111 checks the address of the second terminal 112 in order to transfer a packet to the second terminal 112, a destination, and sets a header of a packet to include packet information including a sender address and a destination address. At step S501, the first terminal 111 transfers a packet 601 shown in FIG. 6 to the third home agent 123, which is a home agent of the third mobile router 123, according to an address confirmed through the receiver address information. The sender address of the packet transferred to the third home agent 123 is the first terminal 201, and the receiver address is the second terminal 112.

At step S502, the third home agent 123 confirms the registered location information. Herein, the third location information registered at the third home agent 123 is MR3→MR1_{CoA} 204. Accordingly, the third home agent 123 adds the third location information 204 to the header of the received packet. Then, the third home agent 123 transfers the head added packet 602 to the first home agent 121. FIG. 6 shows the structure of such a packet. Herein, the sender address of the packet becomes the third home agent HA3 123, and the receiver address becomes MR1_{CoA}.

At step S504, the first home agent 121 receiving the packet from the third home agent 123 confirms the registered location information. Herein, the fist location information registered at the first home agent 121 is MR1→AR_{CoA} 202. Accordingly, the first home agent 123 adds the first location information 202 to the header of the receiver packet from the third home agent. Then, the first home agent 123 transfers the packet 603 with the first location information 202 added to the access router 130 at step S505. FIG. 6 shows the structure of the packet. Herein, the sender address of the packet is the first agent (HA1) 121, and the receiver address is AR_{CoA} 130.

Referring to FIG. 5B, at step S506, the access router 130 receives the packet from the first home agent 121 and transmits the received packet to the first mobile router 141 through the access point 131.

At step S507, the first mobile router 121 restores the received packet and confirms own NEMO routing information 401. Herein, the restored packet is a packet with added headers removed. That is, the restored packet is a packet 601 transmitted by the initial first terminal 111. The NEMO routing information 401, as shown in FIG. 4, is set to transmit a packet to MR2 to the MR1/2 interface and to transmit a packet to transfer to MR3 to the MR1/2 interface. At step S508, the first mobile router 121 transfers the packet 601 to the second terminal 112.

Hereinafter, a method for processing packets transferred from a second terminal to a first terminal according to an embodiment of the present invention will be described.

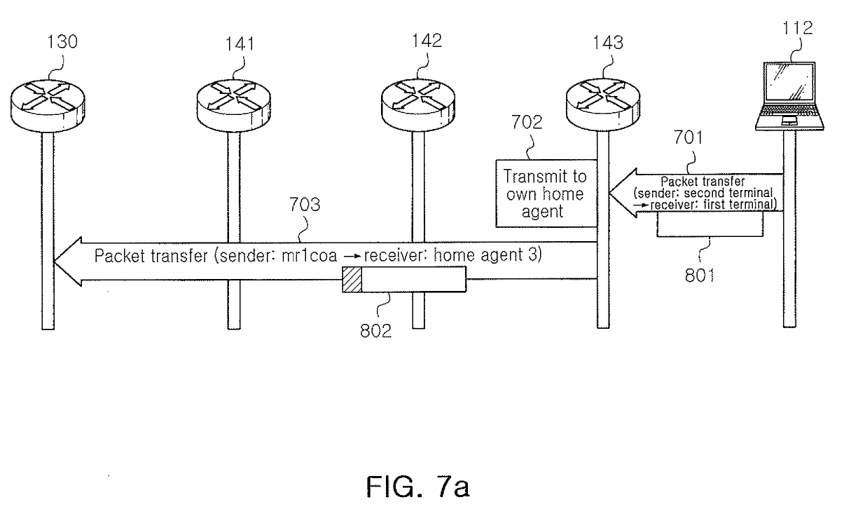

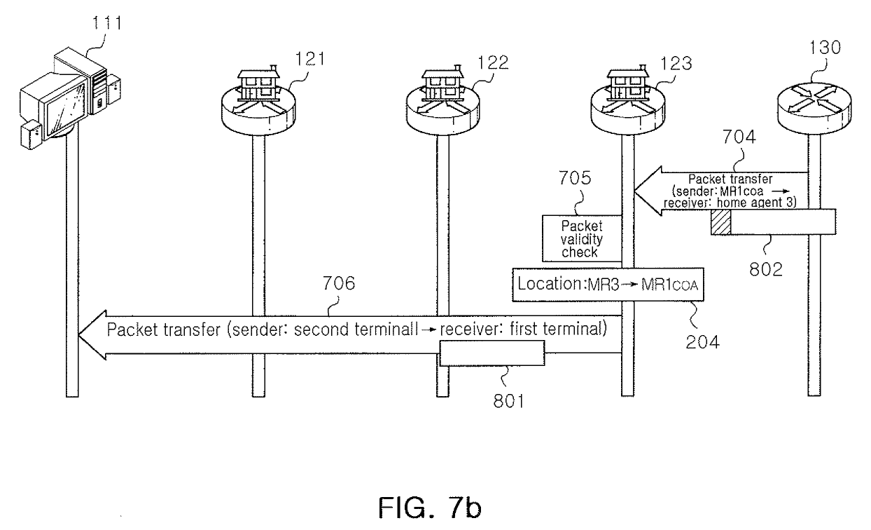

FIG. 7A and FIG. 7B are diagrams illustrating a method for processing packets transferred from a second terminal to a first terminal in a nested mobile network according to an embodiment of the present invention.

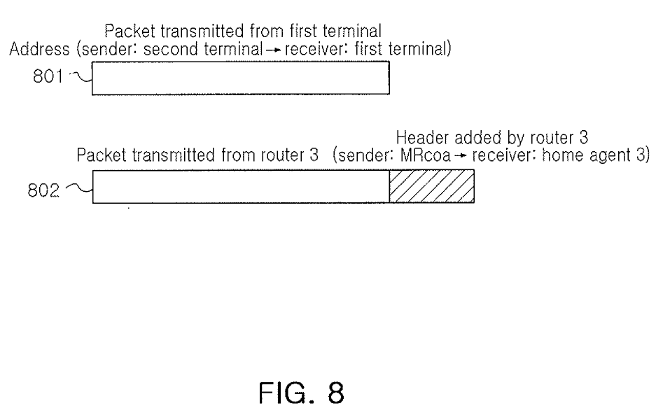

Referring to FIG. 7A, in order to transfer a packet to the first terminal 111, a destination, the second terminal 112 confirms the address of the first terminal 112 and sets the header of a packet to include a sender address and a receiver address. At step S701, the second terminal 112 transfers a packet 801 shown in FIG. 8 to the third mobile router 143 where the second terminal 112 accesses. The sender address of the packet transferred to the third mobile router 143 is the address of the second terminal 112, and the receiver address is the address of the first terminal 111.

At step S702, since the third mobile router 143 receives a packet from a low-level interface, the third mobile router 143 adds a header set to have the address of the third home agent 123 as a receiver address to the packet 801 in order to send it to the home agent of the third mobile router 143. At step S703, the third mobile router 143 transfers the packet 802 having the header shown in FIG. 8 to the access router 130. Herein, the sender address of the packet 802 transferred from the third mobile router 143 to the access router 130 is MR1_{CoA}, and the receiver address thereof is the address of the third home agent 123.

Referring to FIG. 7B, at step S704, the access router 130 transfers the packet 802 shown in FIG. 8 to the third home agent 123 that is set as the receiver address in the header of the received packet 802 by analyzing the header of the packet 802 transferred from the third mobile router 143. Then, the third home agent 123 checks the validity of the packet 802 by confirming the location information (MR3 [symbol] MR1_{CoA} 204) registered at the third home agent 123, and restores the initial packet 801, which is transferred from the second terminal 112, by removing the added header at step S705.

At step S706, the third home agent 123 transfers the packet 801 directly to the first terminal 111.

The mobile routers in the packet transmission route process the packets as described above in order to shorten the packet transmission route. The operation for processing a packet in each router will be described with reference to the accompanying drawings. At first, the operation of the first mobile router, the top-level router, will be described.

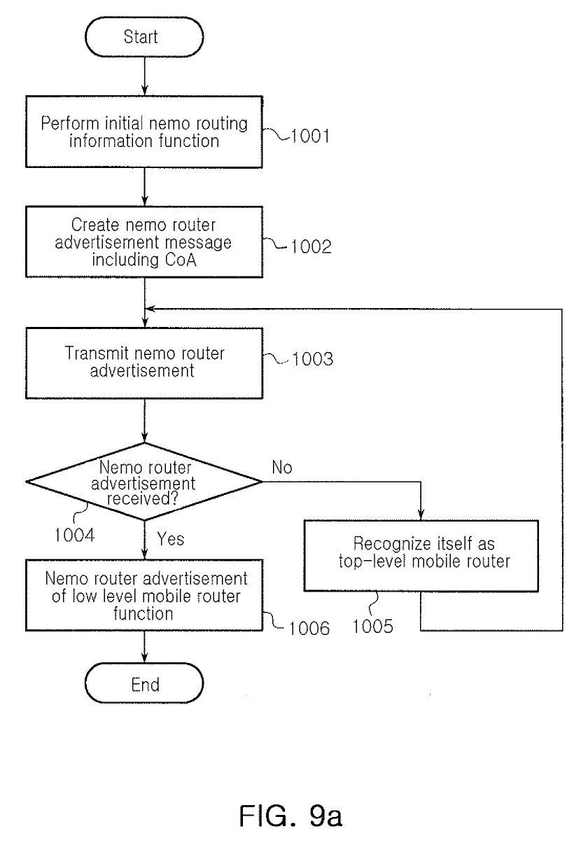

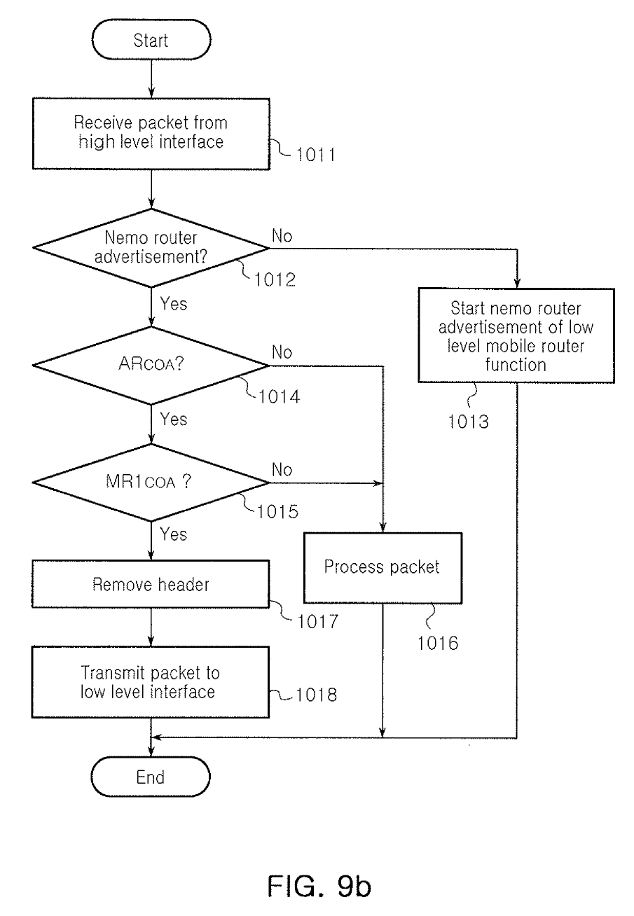

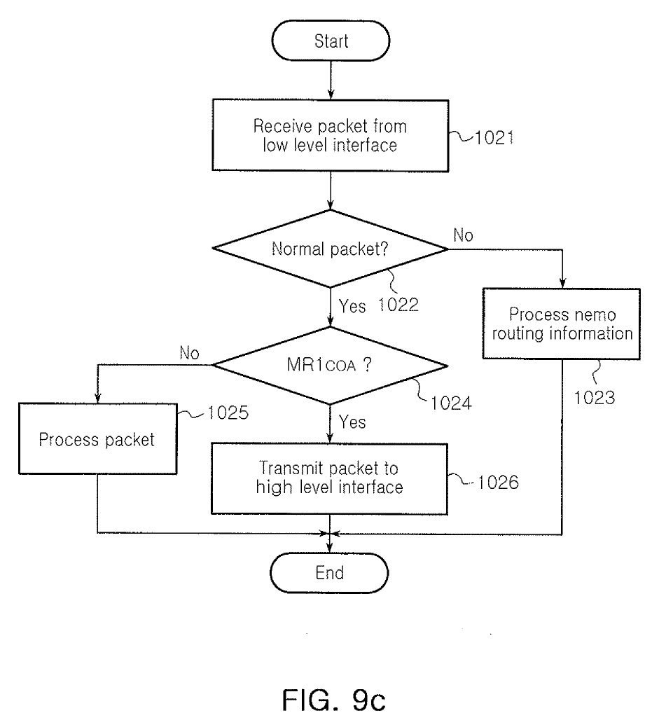

FIGS. 9R through 9C are flowcharts illustrating the operation of a top-level mobile router in a nested mobile network according to an embodiment of the present invention.

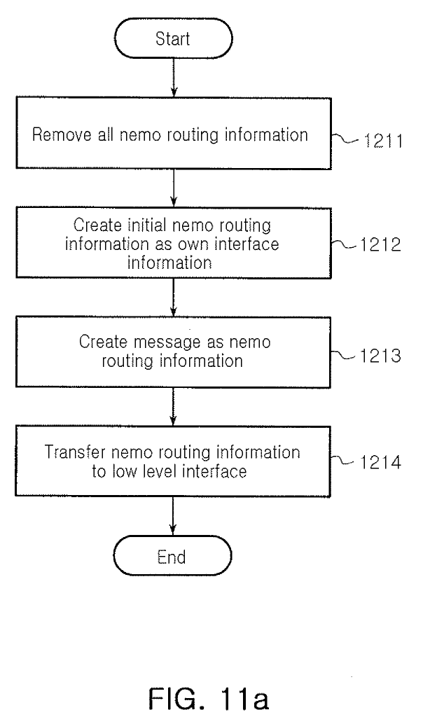

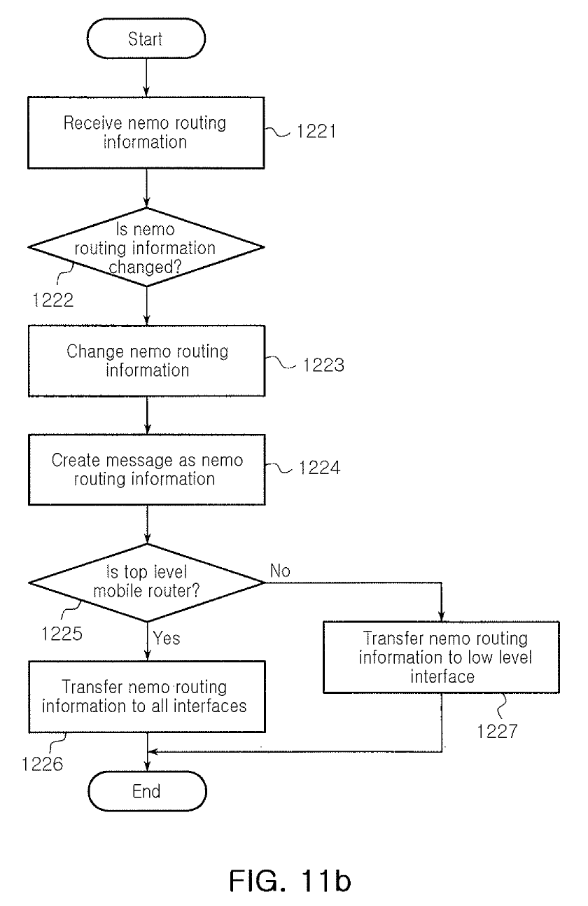

Referring to FIG. 3 and FIG. 9A, at step S1001, the first mobile router 141 performs a NEMO routing information function. The NEMO routing information function will be described with reference to FIG. 11 in detail in later.

At step S1002, the first mobile router 141 creates the NEMO router advertisement message including a CoA with own address (MR1_{CoA}), and transfers the created NEMO router advertisement message to the second and third mobile routers 142 and 143 through a low-level interface at step S1003.

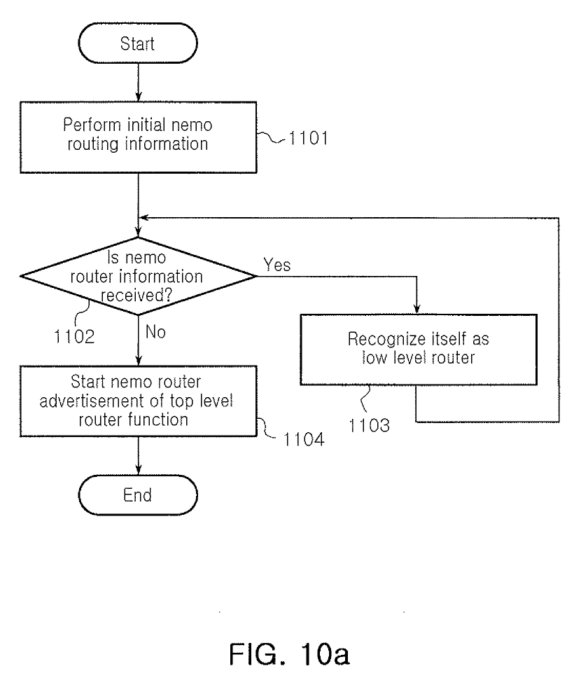

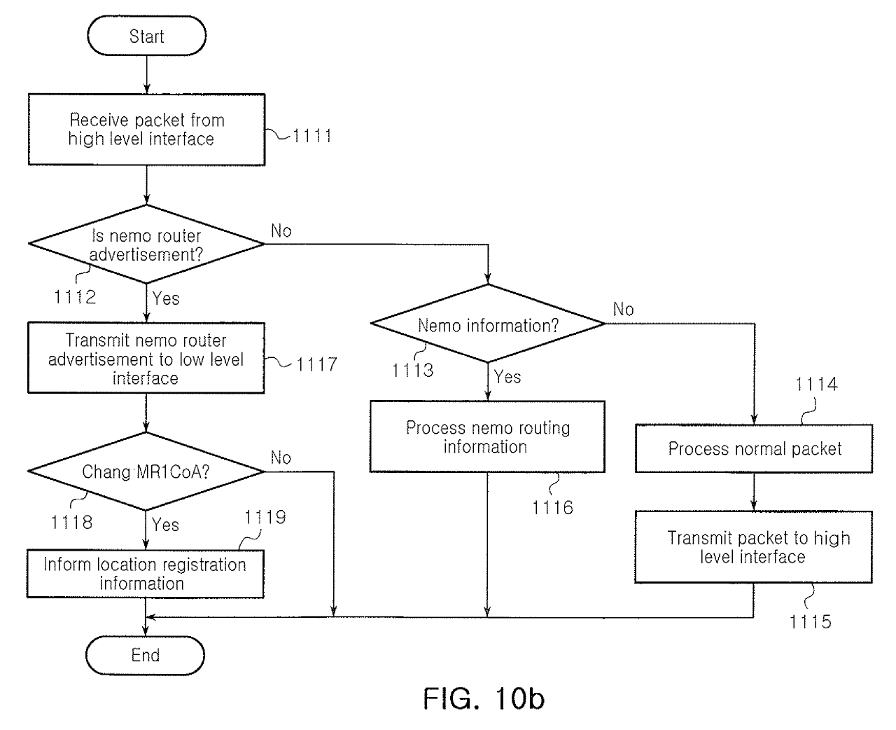

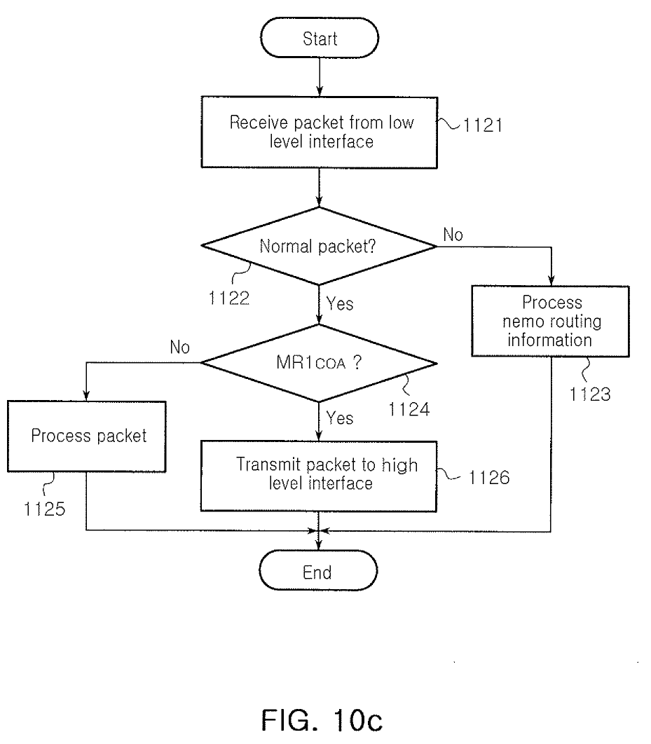

Afterward, the first mobile router 141 checks whether a NEMO router advertisement message is received from a high-level interface or not for a predetermined time. If the NEMO router advertisement message is not received for the predetermined time, the first router recognizes itself as the top router at step S1005. On the contrary, if the NEMO router advertisement message is receiver before the predetermined time is elapsed, the first mobile router 141 performs the NEMO router advertisement as a low-level router function. The NEMO router advertisement is shown in FIG. 10A, and it will be described in detail in later.

Referring to FIG. 9S, the first mobile router 141 receives a packet from the high-level interface at step S1011, the first mobile router 141 determines whether it is the NEMO router advertisement or not by analyzing the received packet a step S1012. If the received packet is the NEMO router advertisement, the first mobile router 141 performs the NEMO router advertisement as the low-level router function.

On the contrary, if the received packet is not the NEMO router advertisement, the first mobile router 141 confirms the receiver addresses in added headers of the packet as the top-level router. At step S1014, the first mobile router 141 determines whether the confirmed sender addresses include CoA of the access router 130 (AR_{CoA}) or not. If the confirmed sender addresses do not include the AR_{CoA}, step S1016 is performed. On the contrary, the confirmed sender addresses include AR_{CoA}, the first mobile router 141 determines whether the sender addresses of the added headers include MR1_{CoA} or not at step S1015. If the sender addresses include the MR1_{CoA}, step S1017 is performed, and if it is the own address (MR1), a general packet process is performed at step S1016.

The first mobile router 141 removes the headers added to the packet at step S1017, and transfers the packet to the second mobile router 142 and the third mobile router 143 through a low-level interface at step S1018.

Referring to FIG. 9C, the first mobile router 141 receives a packet through a low-level interface at step S1021. At step S1022, the first router 141 determines whether the received packet is a normal packet or not. If the received packet is not the normal packet, the first router 141 processes NEMO routing information at step S1023 and terminates the operation of processing the packet.

On the contrary, if the received packet is the normal packet at step S1022, the first router 141 determines whether it is own CoA (MR1_{CoA}) or not at step S1024. If it is not MR1_{CoA}, the first router 141 processes the normal packet at step S1025. On the contrary, if it is MR1_{CoA}, the first mobile router 141 receives a packet through the high-level interface at step S1026.

Hereinafter, the operation of low-level routers will be described with reference to the accompanying drawings. Herein, the low-level mobile router is the second mobile router 142 or the third mobile router 143 shown in FIG. 2 and FIG. 3.

FIG. 10A to FIG. 10C are flowcharts illustrating operation of a low-level mobile router in a nested mobile network according to an embodiment of the present invention.

Referring to FIG. 10A, at step S1101, the low-level mobile router performs initial NEMO routing information. Such initial NEMO routing information will be described with reference to FIG. 11 in later.

After a predetermined time passes, the low-level mobile router determines whether NEMO router advertisement is received or not at step S1102. If the NEMO router advertisement is received, the low-level router recognizes itself as a low-level router at step S1103. On the contrary, if the NEMO router advertisement is not received, the low-level router starts advertisement as the NEMO router advertisement of the top-level mobile router at step S1104.

Referring to FIG. 10B, at step S1111, the low-level mobile router receives a packet through a high-level interface. Then, the low-level mobile router determines whether the received packet is NEMO router advertisement or not at step S1112. If the received packet is not the NEMO router advertisement, the low-level mobile router determines whether it is NEMO information or not by analyzing the received packet at step S1113. If the received packet is not NEMO information, that is, the receiver packet is a normal packet, the low-level mobile router processes the normal packet with reference to NEMO routing information at step S1114. At step S1115, the low-level mobile router transfers a packet through the high-level interface. On the contrary, if the received packet is the NEMO information, the low-level router performs a NEMO routing information processing function at step S1116.

If the NEMO router advertisement is received at step S1112, the low-level router transfers NEMO router advertisement to a low-level interface at step S1117, and determines whether MR1_{CoA} is modified or not at step S1118. If the MRI_{CoA} is modified, the low-level mobile router terminates its operation. If the MRI_{CoA} is not modified, the low-level mobile router informs location registration information to the own home agent 122 or 123 at step S1119 and terminates its operation.

Referring to FIG. 10C, the low-level mobile router receives a packet from a low-level interface at step S1121. Then, the low-level mobile router determines whether the received packet is a normal packet or not at step S1122. If the received packet is not the normal packet, the low-level mobile router performs NEMO routing information process at step S1123, and terminates the operation thereof. If the received packet is the normal packet, step S1124 is performed.

At step S1124, the low-level mobile router determines whether a sender address is MR1_{CoA} or not by confirming the sender address. If it is not MR1_{CoA}, the low-level mobile router performs a normal packet process at step S1125. If not, the low-level mobile router transfers a packet through the high-level interface and terminates the operation thereof at step S1126.

As described above, the initial NEMO routing information is performed when advertising NEMO routing advertisement in the top-level mobile router and the low-level mobile router. A process of creating and processing NEMO routing information will be described with reference to the accompanying drawings.

FIG. 11A and FIG. 11B are flowcharts illustrating a method of creating and processing NEMO routing information in a mobile router in a nested mobile network according to an embodiment of the present invention.

Referring to FIG. 11A, at step S1211, the mobile router removes entire NEMO routing information. At step S1212, the mobile router creates initial NEMO routing information with own interface information. At step S1213, the mobile router creates a NEMO routing advertisement message with the NEMO routing information. Then, the mobile router loads the NEMO routing information into the NEMO routing advertisement message and transfers the NEMO routing advertisement message to the low-level interface.

Then, a mobile router receives the created NEMO routing information, analyzes the received NEMO routing information, and processes the analyzed NEMO routing information. That is, at step S1221, the mobile router receives the created NEMO rolling information, and the mobile router determines whether the NEMO routing information changes or not at step S1222. If the NEMO routing information is not modified, the mobile router terminate its operation.

On the contrary, if the NEMO routing information is modified, the mobile router changes own NEMO routing information at step S1223 and creates a message with NEMO routing information. At step S1225, the mobile router determines whether itself is the top-level router or not. If the mobile router is determined as a low-level router, the mobile router transfers NEMO routing information to all interfaces at step S1127. On the contrary, if the mobile router recognizes itself as the top-level mobile router, the mobile router transfers packets to the low-level interface at step S1127.

According to the certain embodiment of the present invention, mobile routers in a nested mobile network exchange own information, recognize own state, and inform the information of the top-level mobile router in a current network to each home agent. Since each home agent has information about the top-level mobile router, the packet processing route can be shorted by finding the top-level mobile router.

Since each of the mobile routers in a mobile network uses additionally defined routing information by creating additional routing information when mobile routers exchange packets in the certain embodiment of the present invention, the top-level router processes packets and the low-level routers transfer the packets only.

According to the certain embodiment of the present invention, each of the mobile routers in the nested mobile network informs state information of the top mobile level router in a current network to each home agent. Therefore, each of home agents has the information about the top-level mobile router and can find the top-level mobile router. Accordingly, the packet processing route and the packet processing steps can be simplified. Since the length of the packet can be reduced, packets can be uniformly processed.

While the present invention has been shown and described in connection with the preferred embodiments, it will be apparent to those skilled in the art that modifications and variations can be made without departing from the spirit and scope of the invention as defined by the appended claims.

What is claimed is:

1. A method for reducing a packet transmission route comprising:
at a plurality of routers in an Internet based nested mobile network, registering location information using a top-level mobile router;
at each of the mobile routers, creating NEMO (network mobility) routing information;
receiving a packet through own home agent using the location information registered at the top-level router in the nested mobile network when a terminal in the outside of the mobile network transmits a packet; and
processing the received packet through the created NEMO routing information at the top-level router.

2. The method according to claim 1, wherein the step of registering the location information includes:
at the top-level mobile router, registering an address of an access router to own home agent as own location information;
at the top-level mobile router, creating a NEMO advertisement message including an own CoA (Care-of-Address) and transmitting the CoA to at least one of low-level mobile routers; and
at the low-level mobile routers, registering the CoA to own home agent as own location information.

3. The method according to claim 1, wherein the step of creating the NEMO routing information includes:
at each of the mobile routers, identifying a high-level interface and at least one of low-level interfaces; and
creating NEMO routing information by setting high-level/low-level interface of a mobile router to transmit the packet.

4. The method according to claim 1, wherein the step of processing the received packet includes:
restoring the received packet; and
transferring the restored packet to the destination terminal through a low-level interface which is set in the NEMO routing information.

5. The method according to claim 4, further comprising: transferring NEMO router advertisement message as a low-level routing function to a low-level interface according to the mobile routing information if the NEMO router advertisement message is received from the top-level mobile router.

6. The method according to claim 1, wherein the packet receive at the top-level mobile router includes a first header added according to the registered location information at a home agent of the destination terminal, and a second header added according to the registered location information at a home agent of the top-level router.

7. The method according to claim 1, further comprising transferring a packet to own home agent through a high-level interface setting according to own NEMO routing information at a mobile router of a terminal in the mobile network when the terminal in the mobile network transmits a packet, wherein the packet is restored at the home agent of the terminal and transmitted to destination terminal.

8. The method according to claim 7, wherein the step of transferring the packet includes:
receiving the packet from the terminal in the mobile network;
adding a header set to have own location information as a sender address and own home agent address as a receiver address to the received packet, and
transferring the header added packet to the own home agent through the high-level interface and an access router.

9. A system for reducing a packet transmission route comprising:
a top-level router for registering a location to an own home agent, and transmitting NEMO (network mobility) advertisement message having an own CoA (Care-of-Address) and packets received from an external terminal through a low-level interface setting according to previously created NEMO routing information; and
at least one of low-level mobile routers for registering the CoA included in the NEMO advertisement message received from the top-level router to an own home agent as own location information, and transferring a received packet to a destination terminal through high/low-level interface setting according to previously created NEMO routing information.

10. The system according to claim 9, wherein each of the mobile routers identifies the high-level interface and at least one of low-level interfaces, and creates the NEMO routing information by setting a high-level or a low-level interface of a mobile router to transfer the packet.

11. The system according to claim 9, wherein the top-level mobile router registers an address of an access router of an Internet network to the own home agent as own location information, restores a packet received from the external terminal, and transfers the restored packet through a low-level interface set according to the NEMO routing information.

12. The system according to claim 9, wherein when the high-level mobile router receives NEMO router advertisement message through a high-level interface, the top-level mobile router transfers the received NEMO router advertisement message to a low-level interface according to the mobile routing information as a low-level mobile router function.

13. The system according to anyone of claims 11 and 12, wherein the packet receive at the top-level mobile router includes a first header added according to the registered location information at a home agent of the destination terminal, and a second header added according to the registered location information at a home agent of the top-level router.

14. The system according to claim 9, wherein when a terminal in the mobile network transmits a packet, at least one of the low-level mobile routers transfers the packet from a mobile router of the terminal to an own home agent through a high-level interface setting according to own NEMO routing information, the packet is restored at the home agent of the terminal and transmitted to destination terminal.

15. The system according to claim 14, wherein the low-level mobile router adds a header set to have own location information as a sender address and an own home agent address as a receiver address to the packet received from the terminal in the mobile network, and transfers the header added packet to a destination terminal through the own home agent through the high-level interface.
